(19) United States
(12) Patent Application Publication
(10) Pub. No.: US 2006/0077684 A1
(43) Pub. Date: Apr. 13, 2006

(54) LED wall plate night light

(76) Inventor: Se Kit Yuen, Hong Kong (CN)

Correspondence Address: ARTHUR KING MA, 1030 CORONADO DRIVE, ARCADIA, CA, 91007, US

(21) Appl. No.: 10/964,257

(22) Filed: Oct. 12, 2004

(51) Int. Cl. F21V 7/04

(52) U.S. Cl. 362/555

(57) ABSTRACT

The present invention relates to a LED wall plate night light and more particularly, to a LED wall plate night light with a ultra-thin assembly by utilizing a simple light-emitting diode (LED) as a source of illumination and a transparent plastic film. When LED light passes through a transparent plastic film, it generates speeding clear light. The transparent plastic film allows light to form an evenly distributed glow, making it a safe and reliable way of illumination.

### REFERENCED DISCLOSURE DOCUMENT DEPOSIT

This is a non provisional patent application for a disclosure document deposit with disclosure document number 556057 disclosed on Jun. 25, 2004.

### BACKGROUND OF SAID PRESENT INVENTION

1. Field of Invention

The present invention relates to a LED wall plate night light and more particularly, to a LED wall plate night light with a ultra-thin assembly by utilizing a simple light-emitting diode (LED) as a source of illumination and a transparent plastic film. When LED light passes through a transparent plastic film, it generates speeding clear light. The transparent plastic film allows light to form an evenly distributed glow, making it a safe and reliable way of illumination.

2. Description of Related Arts

Conventional night light is often in a form of small; convenient and mobile “puck” lights. These puck lights are so called because they are often round and can be mounted and moved with a minimum of effort. These lights generally utilize fluorescent or incandescent lamps as a light source. Fluorescent and incandescent lamps typically require filaments and cathode tubes for operation. As such, they are fragile and have a relatively short operating life. Furthermore, filament lamps are not the most economical to operate. In addition, by producing light by heating a filament, incandescent lamps generate a great deal of heat. This heat builds up limits the effectiveness of traditional night light due to safety considerations and the possibility of unintentionally and adversely heating items on countertops. This heat generation also makes traditional puck lights less versatile in that some places in which such a light would be desired cannot accommodate a large buildup of heat (e.g. closets, shelves, etc.). Moreover, traditional incandescent and fluorescent lights are quite inefficient. An incandescent light converts a large amount of energy to heat rather than light and fluorescent lamps have a relatively high start up power consumption. Accordingly, new ways to provide more efficient lighting are desired.

As disclosed in U.S. Pat. No. 4,343,032, a night light generally consists of a base portion having prongs, which directly plug into a wall outlet. The base portion has a neck extension, which receives a small wattage bulb. A plastic shade or canopy fits over the bulb and such structure provide a nigh night with a very bulky outfit.

White-light LED systems provide significant benefits over traditional fluorescent and incandescent lamps. As white light producing LED systems become more refined and efficient, a need exists to expand the use of such systems into other areas, such as night light. Conventional fluorescent and incandescent lamps used in night light have multiple components (increasing the cost to manufacture), are fragile, and have a relatively short operating life.

U.S. Pat. No. 6,641,283 discloses an illumination system includes an LED module or housing and a mounting base. A plurality of LEDs is mounted on the module to serve as a light source and generates a light pattern. At least one optical assembly is operatively associated with the housing for focusing and dispersing the light pattern. The housing can be easily mounted and removed from the base unit to provide a flexible mounting architecture. However, again due to the base is required by this LED illumination system, cost of production is higher and a bulky outfit of this LED illumination is a must.

U.S. Pat. No. 6,648,496 provides a night light assembly includes a wall plate adapted to fit over a switch plate extending from a substantially planar surface. The wall plate engages and abuts the substantially planar surface upon mounting the nightlight in its final operating position. At least one light emitting diode (LED) is mounted within the wall plate, which serves as the light source for the nightlight. This patent suggests a manner to provide a slimmer night light however, due to the nature of conventional LEDs, a relatively short-time-life of such LED illumination is remain an unsolved problems.

### SUMMARY OF SAID PRESENT INVENTION

A main object of the present invention is provide a LED wall plate night light by utilizing a simple light-emitting diode (LED) as a source of illumination and a transparent plastic film so as to provide a thin, slimmer outfit of a wall plate night light.

Another object of the present invention is provide a LED wall plate night light by utilizing a simple light-emitting diode (LED) as a source of illumination and a transparent plastic film simple light-emitting diode (LED) as a source of illumination and a transparent plastic film. When LED light passes through a transparent plastic film, it generates speeding clear light. The transparent plastic film allows light to form an evenly distributed glow, making it a safe and reliable way of illumination.

Another object of the present invention is provide a LED wall plate night light by eliminating all unnecessary components to a night light such as canopy, base and even switch plate so as to achieve an ultra thin LED wall plate night light with the least cost of production.

Accordingly, in order to accomplish the above objects, the present invention provides a LED wall plate night light, which comprises:

a housing consists of a front panel and a back panel,

a protective cover including an optical assembly for focusing and dispersing LED emitted light to a desired light contour enclosing at least a portion of the housing; and

at least one light-emitting diode (LED) as a illuminant, and

a plurality of circuit boards with a plurality of polyester cover capacitors, a plurality of resistances, a plurality of metal power plug, and

at least one transparent films, and

at least one protective semi transparent film, and

at least one piece of white film.

### BRIEF DESCRIPTION OF SAID DRAWINGS

FIG. 1 is a front view of the present invention.

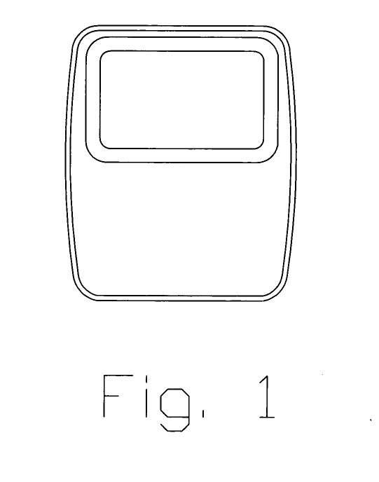

FIG. 2 is a side sectional view thereof;

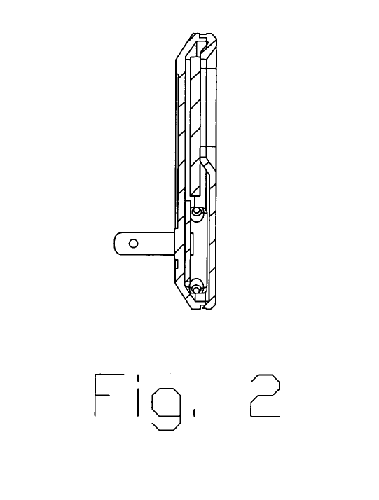

FIG. 3 is a top view thereof;

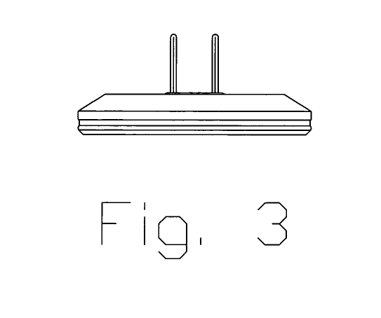

FIG. 4 is a bottom view thereof;

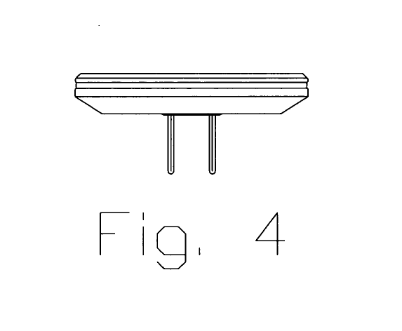

FIG. 5 is a rear view thereof;

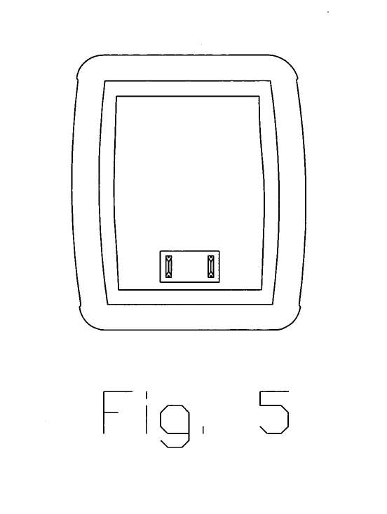

FIG. 6 is a side view thereof;

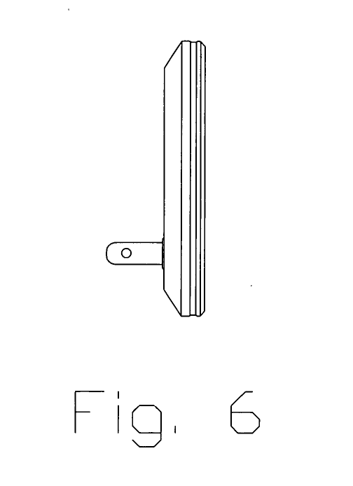

FIG. 7 is a perspective view thereof;

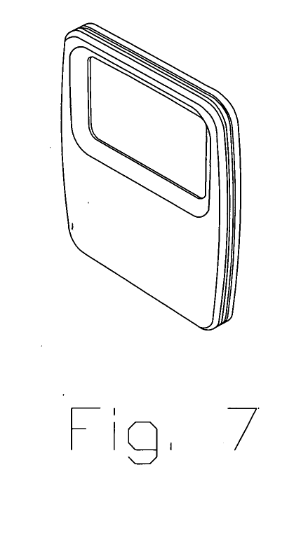

FIG. 8 is another perspective view thereof;

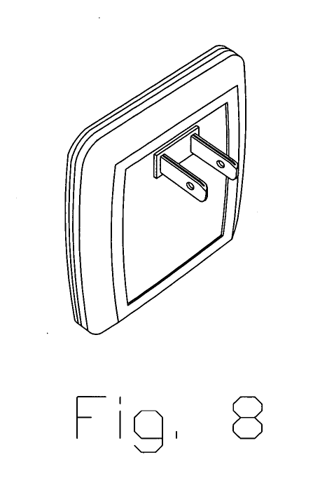

FIG. 9 is an assembly structural view of the present invention.

### DETAILED DESCRIPTION OF SAID PREFERRED EMBODIMENT

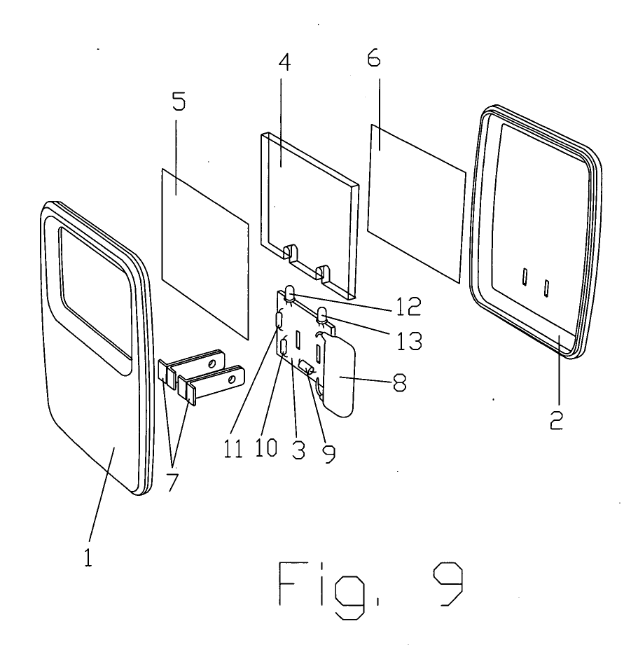

Referring to FIG. 9, this LED wall plate night light has a housing consists of a front panel (1) and a back panel (2). Said panel has no predetermined shape. It can be rectangular, round and any other shape depending on any specification ordered. Inside of said front and back panels, a circuit board (3), a transparent film (4), a protective semi transparent film (5), a white film (6) and a metal power plug (7) are clamping together therein. Said metal plug (7) is affixed on said circuit board (3). It passes through two holes on a lower portion of said back panel (2) while said circuit board (3) is affixed in between said front panel (1) and back panel (2).

Said circuit board (3) contains a metal polyester covering capacitor (8), two resistances (9 & 10), one diode (11) and two light-emitting diodes (12) and (13). Surface of said front panel has a display window with a predetermined size and shape, which contains a transparent plastic film conforming with said predetermined size and shape of said hole. As electrical current passes through said metal power plug (7) into a circuitry that lowers down 120 voltages to a level that activates said light-emitting diode (12) and (13) and light is thereby transmitted. Said light passes through said transparent film (4), generates speed light, and said transparent plastic film (4) allows light to form an evenly distributed glow, making it a safe and reliable way of illumination.

Said LED wall plate night light provides an ability to adopt power source directly on any wall outlet of AC (alternate current), which is provided by any public utility provider. As electricity passes through said circuit board (3) inside of said front panel (1) and back panel (2), lower down 120 voltages from AC to activate the light-emitting diode to illuminate.

After LED light passes through a transparent plastic film, it generates speeding clear lights which can remain stable over an extended period of time and will not affected by any weather condition. The transparent plastic film allows light to form an evenly distributed glow. The electric circuit module includes a circuit board, a metal like polyester covering capacitor, two resistances, one diode and two light-emitting diodes.

It is the lifespan of said LED (12) and (13) to offer at least 100,000 light hours, therefore, said LED wall plate night light provides a relative longer usage than conventional night lights.

What is claimed is:

1. A LED wall plate night light comprises:
a housing consists of a front panel and a back panel,
a protective cover including an optical assembly for focusing and dispersing LED emitted light to a desired light contour enclosing at least a portion of the housing; and
at least one light-emitting diode (LED) as a illuminant, and
a plurality of circuit boards with a plurality of polyester cover capacitors, a plurality of resistances,
a plurality of metal power plug is affixed on said circuit board and it passes through two hold on a lower portion of said back panel while said circuit board os affixed in between said front panel and back panel, and
at least one transparent films, and
at least one protective semi transparent film, and
at least one piece of white film.

2. A LED wall plate night light as recited in claim 1, wherein, said circuit board further comprises:
a plurality of metal polyester covering capacitors,
a plurality of resistances,
at least one diode and a plurality of light-emitting diodes.

3. A circuit board as recited in claim 1, wherein said LED wall plate night light provides an ability to adopt power source directly on any wall outlet of AC (alternate current), which is provided by any public utility provider.

4. A LED wall plate night light as recited in claim 1, wherein said front panel and back panel has no predetermined size and shape.

5. A LED wall plate night light as recited in claim 1, wherein surface of said front panel has a display window with a predetermined size and shape, which contains a transparent plastic film conforming with said predetermined size and shape of said hole.

6. A LED wall plate night light as recite in claim 1, wherein, as electrical current passes through said metal power plug into a circuitry that lowers down 120 voltages to a level that activates said light-emitting diodes and light is thereby transmitted. Said light passes through said transparent film, generates speed light, and said transparent plastic film allows light to form an evenly distributed glow, making it a safe and reliable way of illumination.

7. A LED wall plate night light comprises:
a housing consists of a front panel and a back panel,
a protective cover including an optical assembly for focusing and dispersing LED emitted light to a desired light contour enclosing at least a portion of the housing; and
at least one light-emitting diode (LED) as a illuminant, and
a plurality of circuit boards with a plurality of polyester cover capacitors, a plurality of resistances,
a plurality of metal power plug is affixed on said circuit board and it passes through two hold on a lower portion of said back panel while said circuit board os affixed in between said front panel and back panel, and
at least one transparent films, and
at least one protective semi transparent film, and
at least one piece of white film.
Wherein said circuit board further comprises:
a plurality of metal polyester covering capacitors,
a plurality of resistances,
at least one diode and a plurality of light-emitting diodes.

8. A circuit board for LED wall plate night light comprises:
a plurality of metal power plug, and
a plurality of metal polyester covering capacitors, and
a plurality of resistances, and
at least one diode and a plurality of light-emitting diodes. wherein, as electrical current passes through said metal power plug into a circuitry that lowers down 120 voltages to a level that activates said light-emitting diodes and light is thereby transmitted. Said light passes through said transparent film, generates speed light, and said transparent plastic film allows light to form an evenly distributed glow, making it a safe and reliable way of illumination.

9. A circuit board as recited in claim 7, wherein said LED wall plate night light provides an ability to adopt power source directly on any wall outlet of AC (alternate current), which is provided by any public utility provider.

10. A circuit board as recited in claim 8, wherein said LED wall plate night light provides an ability to adopt power source directly on any wall outlet of AC (alternate current), which is provided by any public utility provider.
